(19) United States
(12) Patent Application Publication
(10) Pub. No.: US 2004/0186852 A1
(43) Pub. Date: Sep. 23, 2004

(54) Internet based system of employment referencing and employment history verification for the creation of a human capital database

(76) Inventor: Les Rosen, Novato, CA (US)

Correspondence Address: JOHNSON & STAINBROOK, LLP, 3558 ROUND BARN BLVD., SUITE 203, SANTA ROSA, CA, 95403, US

(21) Appl. No.: 10/699,724

(22) Filed: Nov. 3, 2003

Related U.S. Application Data
(60) Provisional application No. 60/422,969, filed on Nov. 1, 2002.

(51) Int. Cl. G06F 17/00

(52) U.S. Cl. 707/104.1

(57) ABSTRACT

A method for creating, editing and updating, verifying, and referencing a database of work, educational, and licensing histories of workers includes an internet service which provides a secure means for prospective employees to enter and record on a database a personal educational and job history covering any time period. The invention includes a software “back office” backbone, which provides a semi-automated means for verifying the history provided by the job applicant and for building a verified database of workers. This software is the engine for the internet service. The invention also provides a secure, confidential and private means for a prospective employer (with the prospective employee's authorization) to review the verified educational, employment, criminal, and licensing history of the worker.

### CROSS REFERENCE TO RELATED APPLICATIONS

The present application claims the benefit of the filing date of U.S. Provisional Patent Application Ser. No. 60/422,969, filed 01 Nov. 2002.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention relates generally to software-mediated, internet based methods of providing an employment database, and more particularly to a method of providing rapid access to a database containing the verified work, educational, and licensing histories of workers. The internet site is designed to serve both prospective employers and prospective employees.

### BACKGROUND INFORMATION AND DISCUSSION OF RELATED ART

Nearly every time someone gets a new job, employers need to conduct reference checks from past employers. However, the process has not changed substantially since the invention of the telephone. There is no nationwide verified database of past employment for employers to review.

The procedures for a prospective employer to check the educational, employment, criminal, and licensing history of a prospective employee are time consuming, expensive, and labor intensive. It is also time consuming for workers to maintain educational, employment, and licensing and credential histories, for review by prospective employers.

The U.S. civilian labor force is notable for its size and its geographic and career mobility. As of April 2002, there are 141.4 million American workers, with an unemployment rate of 5.7%, or 8 million people. 73% of workers—102.7 million people—are employed in managerial & professional positions (30.2%), technical, sales and administrative support (29.2%) positions, and in service jobs (13.5%). Workers typically summarize their employment, training and education in a resume. More than 20 million separate resumes are posted on online job boards, meaning that at any point in time, more than one in seven Americans is considering or seeking new employment.

A recent report by the Society of Human Resource Management finds that 96 percent of job seekers use the Internet to search for work. Approximately 25 percent of new hires come via company Web sites today; non-company job-board hires should reach as high as 20 percent during the next few years.

Today, firms either verify credentials themselves or outsource to a variety of background checking firms, with prices ranging from $60-$450 per candidate. Each time a job candidate seeks to change employers, his or her background is verified anew. For job candidates speaking with multiple prospective employers, a person's background may be verified for each company seeking verification. Businesses that verify employment, education and training repeat the same work another firm did the last time the job candidate changed jobs. A national bureau holding verified employment, education and training records would significantly reduce this inefficiency.

The TALX Corporation collects employment records from large employers, but it is for the purpose of providing job verification to others on the employer's behalf. They do not provide referencing services or build an employment history on individual workers. They provide employee self-service solutions, to large organizations such as government agencies and Fortune 1000 companies.

Other firms provide pre-employment screening. The largest firm is ChoicePoint. Other large firms include Trans Union, CIC, Avert and Pinkerton. However, each of these firms are essentially retail firms in the background screening industry. It is not likely that the bulk of the background industry would trust them to act as an outsource provider of reference checking services. In addition, there would be a substantial lag time for a firm to develop and implement the technology that is needed.

The foregoing references reflect the current state of the art of which the present inventor is aware. Reference to, and discussion of, these references is intended to aid in discharging Applicant's acknowledged duty of candor in disclosing information that may be relevant to the examination of claims to the present invention. However, it is respectfully submitted that none of the above-indicated references disclose, teach, suggest, show, or otherwise render obvious, either singly or when considered in combination, the invention described and claimed herein.

### BRIEF SUMMARY OF THE INVENTION

The present invention comprises a method for creating, editing and updating, verifying, and referencing a database of work, educational, and licensing histories of workers.

In the preferred embodiment, the inventive system comprises an internet service which provides a secure means for prospective employees to enter and record on a database a personal educational and job history covering any time period. The invention includes a software “back office” backbone, which provides a semi-automated means for verifying the history provided by the job applicant and for building the largest verified database of workers in the world. This software is the engine for the internet service. The invention also provides a secure, confidential and private means for a prospective employer (with the prospective employee's authorization) to review the verified-educational, employment, criminal, and licensing history of the worker.

The invention is a web-based application designed to enable the rapid, semi-automated fulfillment of orders for employment verifications and reference checks, an activity carried out primarily over the telephone by operators with a minimum of training. The invention includes software which allows customers to place orders directly through a graphical user interface. Orders are databased and fed into a queue based on the first-in-first-out (FIFO) rule. Orders in the queue are fed to operators who are set up at workstations configured to autodial by modem each new order as soon as the previous order is completed. Operators work from scripts that resolve in either/or decisions which activate successive scripts and decisions designed to deal with every variable that may be encountered in the employment verification and reference check process. The operator's role, the central function of the software, is supported by three other roles and subsequent branches of the software; the clerk, researcher, and business owner. These supporting roles and software functions are described in the functional specifications infra.

The goal of the software is to increase the number of orders that can be fulfilled per hour by automating as much of the process as possible. The ultimate benefits are increased margins and the creation of a database which contains the employment history of a large population of working Americans.

An expanded description of the invention is provided in the attached pages, as are the functional elements of the entire inventive internet-based employment referencing service and employment history database.

It is therefore an object of the present invention to provide a new and improved universal applicant credential record.

It is another object of the present invention to provide a new and improved national database of job applicants.

A further object or feature of the present invention is a new and improved ability for job applicants to verify their credentials for life.

An even further object of the present invention is to provide a novel way for employers to access applicant's credentials over the internet.

Other novel features which are characteristic of the invention, as to organization and method of operation, together with further objects and advantages thereof will be better understood from the following description considered in connection with the accompanying drawing, in which preferred embodiments of the invention are illustrated by way of example. It is to be expressly understood, however, that the drawing is for illustration and description only and is not intended as a definition of the limits of the invention. The various features of novelty which characterize the invention are pointed out with particularity in the claims annexed to and forming part of this disclosure. The invention resides not in any one of these features taken alone, but rather in the particular combination of all of its structures for the functions specified.

There has thus been broadly outlined the more important features of the invention in order that the detailed description thereof that follows may be better understood, and in order that the present contribution to the art may be better appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is neither intended to define the invention of this application, which is measured by the claims, nor is it intended to be limiting as to the scope of the invention in any way.

Certain terminology and derivations thereof may be used in the following description for convenience in reference only, and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

### BRIEF DESCRIPTION OF THE SEVERAL VIEWS OF THE DRAWINGS

The invention will be better understood and objects other than those set forth above will become, apparent when consideration is given to the following detailed description thereof. Such description makes reference to the annexed drawings wherein:

FIG. 1 is block diagram showing the general functional components of the invention;

FIG. 2 is a flow diagram showing the process and method steps for general use of the invention's website;

FIG. 3 is a flow diagram showing the process and method steps connected with a job applicant's use of the invention's website;

FIG. 4 is a flow diagram showing the process and method steps connected with an employer's or a recruiter's use of the invention's website; and

FIG. 5 is a flow diagram showing the process and method steps connected with the site administrator's management of the invention's website.

### DETAILED DESCRIPTION OF THE INVENTION

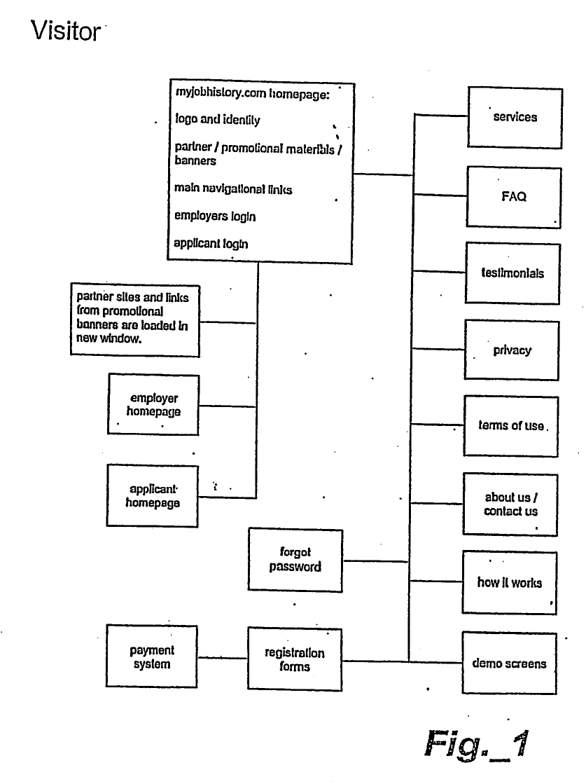

FIG. 1 is block diagram showing the general functional components of the invention;

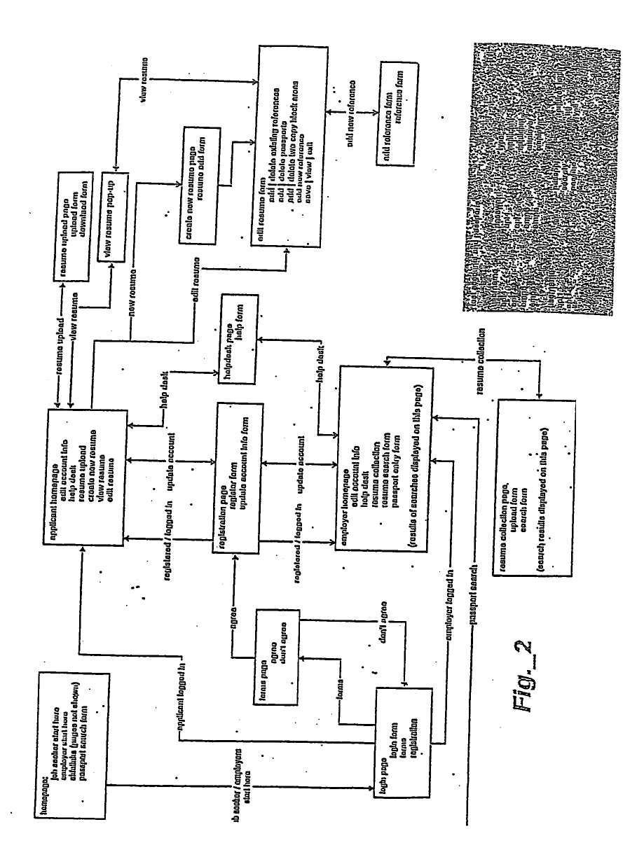

FIG. 2 is a flow diagram showing the process and method steps for general use of the invention's website;

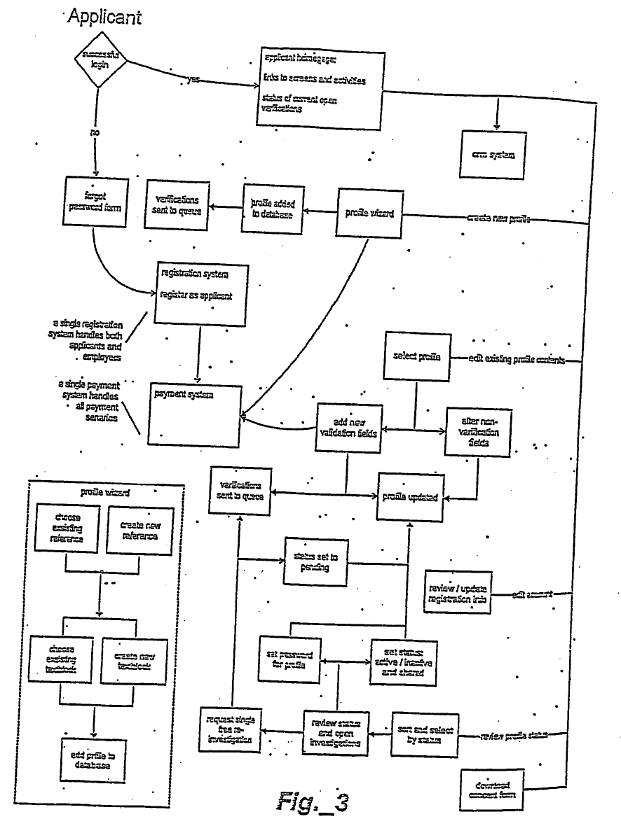

FIG. 3 is a flow diagram showing the process and method steps connected with a job applicant's use of the invention's website;

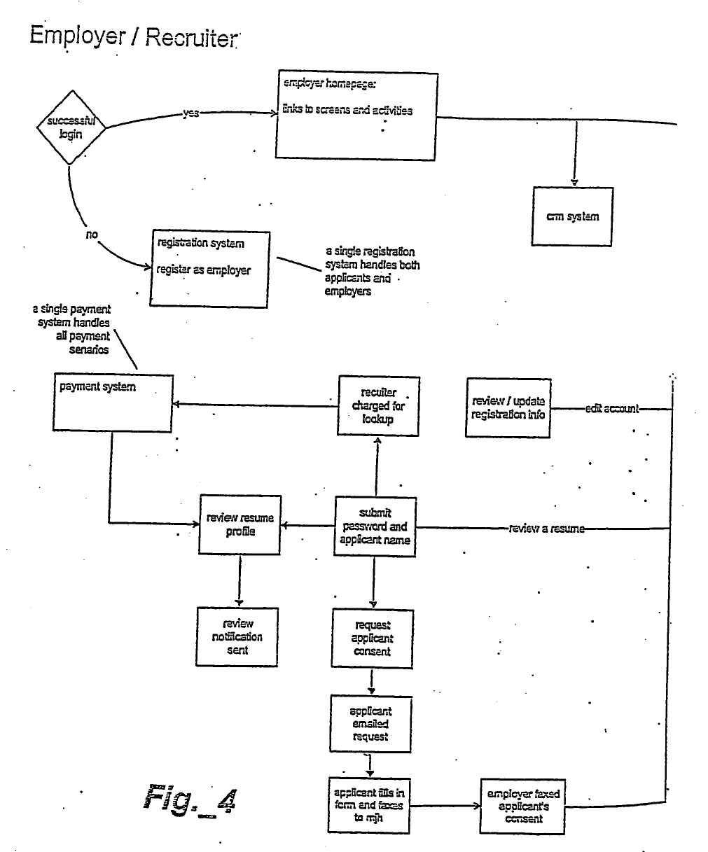

FIG. 4 is a flow diagram showing the process and method steps connected with an employer's or a recruiter's use of the invention's website; and

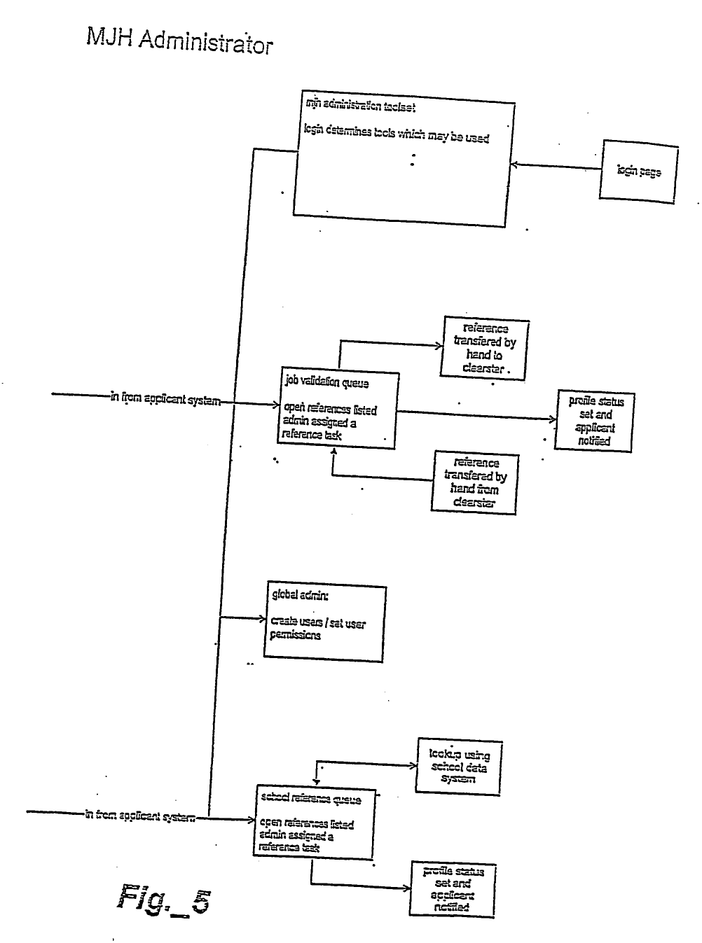

FIG. 5 is a flow diagram showing the process and method steps connected with the site administrator's management of the invention's website.

The following description focuses on the back-end requirements of the project. A separate matter, not described here, is the GUI/Design of the site. All component code will be written so as to be easily integrated into an existing set of HTML templates as written by the HTML programmers doing the GUI.

The present invention provides a website whereby a job seeker (applicant) has the ability to post a set of job history and educational references as being true information, validated by a trusted third party. Potential employers and recruiters use the system to look up this validated information—thus saving time and effort traditionally spent by company HR department.

The primary unit of data for this system is the applicant profile. A profile is a resume of objective and subjective information.

There are three types of users for this system: Employer/Recruiter: uses the applicant lookup features of the system; Applicant: creates reference profiles for potential employers/recruiters to see; and Operator: does the work of job and degree validation as well as administration.

Validation of job history data will be initially carried out manually, through the use of known systems. The Operator user will obtain verifications and will manually enter this data into the system.

Validation of job history data will eventually be carried out by an external employment references verification system. The operator, using a component internal to the system, will still carry out validation of school references.

Only job and educational references will be carried out by this system. Subjective and personal references are not part of this system's work.

There are four main areas of development for the set of components outlined here: Internet: The public website; Intranet: The employer and applicant tools; Integration with the Employment References verification system; and Licensing: Education and Professional Licenses verification system.

Discovery

Needs Discovery: This tasks addresses all work done in researching the needs and parameters of the project's systems. For example, the Licensing component will need to import data about schools.

Formal Project Specification: A detailed specification will be created to describe each of the components in the detail necessary to program them. This specification will contain a complete database schema, and sitemap. It will also include information specific to the server environment needs.

Setup Development Environment: A development environment will be setup and configured for the project. This environment will host a staging version of the site and database(s). All work will be done on this environment and completed pages will be self-contained so as to be easily uploaded to a live server.

Setup and Design Data Environment: This task is for all work necessary in creating and configuring the local datasources. The database will be SQL7. Database tables will be created to contain all data used by the system: employer, applicant, schools, etc. The applicant profile data will be stored so as to be easily transformed out of SQL into a variety of formats. This will be done in anticipation of having job boards be able to access this data in the future.

Internet

GUI/HTML for Dynamic pages: There are several dynamic pages throughout the site —mostly on the Intranet. These pages are not static, and display information dependent on the type of user and that user's requests. This task addresses the work required in designing and implementing the HTML for all dynamic Internet, Intranet and back-end pages. The Intranet pages will follow, as much as possible, the GUI designed for the website.

CRM System: It has been decided that the inclusion of the CRM system should not be a 3^{rd} party implementation, but should be a part of the existing queue system. The system has been programmed to allow the easy inclusion of a simple CRM queue item. There will be a Help Page for use by all registered applicants and employers. At this page, a user will choose a category and state his/her question/comment. Several categories such as general, billing, suggestion, technical, etc will be available. Questions will be submitted to the queue for processing. The queue system will be modified to include CRM as an additional type of queue item.

User Sign Up Page: Employers and Applicants will both be required to sign up for service. In both cases, there will be a defined set of registration data collected. The system will have a cookie placed on the user's computer allowing them to be recognized upon re-entry to the site.

Applicants are required to give all registration information. Employers/Recruiters may a minimal set of data (contact name, company name, email, zip code) or a more detailed set. To be remembered, an optional password must be provided. To use the Recruiter search tool, all information is required.

After sign up, the users will be redirected to their appropriate homepage. At sign up, users will indicate weather or not they wish to be included on a newsletter email list. Applicants will also indicate a secret phrase that may be used by the operator to verify the authenticity of a person during phone conversations as well as other privacy-related issues. There is a one-time setup fee for Applicants.

User Login Page: All users will login upon first time use and re-entry to the Intranet pages. A failed login will result in the users being asked to sign up for the appropriate service. Successful logins by employers and recruiters will take them to the applicant review screen. Successful logins by applicants will take them to the profile management system.

Intranet

Employer's Applicant Review Screens: There are three ways in which applicant profiles may be viewed: Employer/Recruiter lookup, recruiter searches, and Job-Board usage. Employers and Recruiters will be able to pull up an applicant's profile via a password that the applicant has assigned to a specific profile. The initial review screen will allow the input of an applicant's name and a password associated with a profile. The next review screen will allow the user to view profile information as being verified, or request consent from the applicant. The user will also be able to view a printer friendly version of this page. The recruiter search tool will allow recruiters to pull up one or more profiles based on a search query. Job-Board usage is basically the release of profile information to participating Job-Board partner sites.

Employers/Recruiters will be required to register to view profiles, only if that profile has been flagged by the owner Applicant as requiring employer registration.

Recruiter Search Screen: Recruiters will have a search tool that allows them to search the database of profiles. A recruiter will enter in a search phrase and up to 4 zip codes. Searches will be filtered this search phrase and the zip code(s). Only public profiles are searchable. Profiles having no geographical locations associated with them will be assumed to be open to all locations.

Employers/Recruiters wishing to use this system must be registered with full registration data. Should registration data be required or missing, the user will be redirected to the employer registration screen.

Employer Consent Form: There will be some situations in which the employer user needs to get consent to view an applicant's profile. There will be a universal consent form to be used by all applicants needing to give consent. After employees log in and enter in an applicants name and password, they will be able to request this consent. The applicant is then emailed, instructing him/her to download the form, and fax it to the operator who will then fax it to the employer. The employer may then use the system to view the profile.

Review Notification: Every time an employer or recruiter views an applicant's information, that applicant will be notified via email that a review has occurred. As much information as possible about the employer will be included in this email.

Applicant's Profile Management System: Every unique applicant account has associated with it two types of data: references and subjective text blocks. References are objective, verifiable data points. The subjective text blocks contain text data as entered by the applicant. Associating one or more references with one or more subjective text blocks creates a profile. The Applicant Management System is a suit of tools that allows the applicant to add, edit, and delete these information profiles.

When an applicant creates a profile, he/she adds references and subjective text into a resume. The applicant may add from existing/verified references and existing subjective text blocks. The applicant may also add new references to be verified, as well as new text blocks. There are two template styles that this information may be assembled into: (from top-to-bottom) textblock, references, textblock, textblock; or reference, textblock, reference, textblock. There may only be as many textblocks per profile as there are references.

Once a reference is verified, it may be used on up to 4 different profiles.

Each reference has a status of: new, pending, and complete. It is also flagged as verified or unverified. A profile has a status of: new, pending, completed, active, or inactive.

The operator checks each reference, updating its status as verification is completed. When there is a reference that cannot be verified, the applicant is notified, and given the opportunity to supply further information for a re-investigation of that reference. A profile is flagged as completed when all its associated references have been verified to the best of the operator's ability. The applicant is informed of this status change and is asked to activate the profile, marking it as active. Should there be any reference that was unverifiable, the applicant may use the subjective text area to comment on that reference. An applicant may update a profile's active/inactive status at any time after it has been defined. Only those references that have been completed will be displayed upon employer viewing. Applicants will have an “employer's view” review screen allowing them to see the profile as it looks to the employer/recruiter.

Each profile has associated with it a set of passwords/companynames and then distributes passwords to potential employers/recruiters. The password is the key to the profile. Each password is associated with a company name. This name is used as a greeting upon viewing the profile. This name may be left blank—in which case it is not used in the greeting. Each profile may have up to 10 such password/companyname keys. Applicants may download a unique “seal of authenticity” for any completed profile. This seal will be a graphic that includes a unique identifier number. This seal may then be used on any printed profile.

Applicants will also set the permissions for recruiter searches and job-boards. Profiles are flagged as being public or private. A private profile may only be viewed via its password. A public profile may be released to job-boards and is accessible to the recruiter search engine. Applicant may define whether or not a public profile is blind (will include any personal information) or not, and may include a block of text targeted to recruiters.

Applicants may further define the local geography for a profile, indicating the geographical areas the applicant is interested in working. Geography will be defined as a set of zipcodes and/or states.

Applicants will set a flag to indicate whether or not a profile should require an employer/recruiter to register to view it. Registration will collect more information for the Applicant to see upon been email-notified of the view.

The Applicant homepage will show the status of all profiles requiring attention.

On fees: the operator checks each given reference for a set fee. The first reference given by an applicant is free. An applicant may request one free re-investigation of a problematic reference.

Applicant's Verifications Review Screen: As an applicant's data is reviewed and validated by the employment references verification system and the Licensing validation system, the applicant may want to see the status of this process. This screen will show the applicant all pending data being validated, and the status of each data point. As a profile's references are completed, the applicant will be asked to review it, and mark it as active or inactive. An applicant may update a profile's active/inactive status at any time.

Payment and Merchant Bank System: There are three areas where fees for servers are tendered: Applicant Signup, Applicant profile creation, and Recruiter lookup. Each applicant signup requires the applicant to pay a one-time nominal setup fee. For each reference within a profile, a fee is charged as well. All recruiters will be required to pay for each applicant lookup as well. The signup registration process will obtain credit card information to be used during these transactions. This task involves all programming necessary to effect merchant bank integration.

Promotional Code System: There will be a simple system that allows the use of a promotional code for payment discounts. Promotional codes may be used in a variety of ways. One area of use that has been identified is that of giving out codes via partner job-board sites. Potential applicants will get a code, visit the site and use the code to obtain a discount on a payment. This system will be simple to begin with and may be expanded upon later as required.

For example: 1. Promotional code is taken at screen where money is taken. 2. Code owner is notified via email of code use and usage is stored in database table for accounting. 3. There is a simple tool that allows the operator admin to pull code usage data in spreadsheet format. 4. There is no integration at this time with accounting software. 5. Applicant discounts are in the form of an automatic percentage discount on the payment to be made. 6. Partner rebates are a percentage of the amount taken and are done manually outside of the merchant bank system. Schema: company, code, company_rebate, ttl, applicant_discount.

User Management: The validation system, and general administration, will require the ability of known employees to login and use the system. These users will be involved in the activity of validating job and school references given by applicants. This task is for the creation of an administration system to manage these users: add, edit, and delete usernames and passwords.

eMail List Tool: Users will have the ability to query the user tables for email addresses. Queries will be by one or more of date range, user type, and references. Results will be packaged into a downloadable csv file suitable for import into any local database or spreadsheet program.

Employer Resume Collection Service: This system will allow an employer to collect resumes or job applications from applicants. The system is basically a simple document management system in which the employer manages two types of documents: one is a single request document, most likely a job application form, and all others are response documents uploaded by applicants.

When employers register, they may include an additional field of “EmployerIdent” with their account information. This field is a type of password that employers may choose for themselves and is alphanumeric. An employer may then pass out this identity value to potential applicants. Applicants, using this EmployerIdent value, can then upload documents intended for receipt by that employer.

Upon registration, applicants will have the option of including an EmployerIdent value. Should they provide a valid one, the registration will be free.

The applicant homepage will have two new tools: an employer request download and an employer response upload. The download tool will allow an applicant to enter in an EmployerIdent to download the associated request document. The upload tool allows an applicant to upload a response document. Uploaded documents will need to supply a valid EmployerIdent as well as a descriptive text value for that upload. This value will most likely be the job description as indicated by the employer when supplying the EmployerIdent value to applicants. There will also be a 2^{nd} field that solicits information on the applicant's skills. Upon upload, the document is available to the employer, and a receipt email is sent to the applicant.

Applicant may choose to link a Resume, should they take advantage of this service, to the employer. This is done by using the EmployerIdent as one of the passports for one or more Resumes.

The employer homepage will include a new tool for uploading a single request document. This document will usually be a job application or other such document. Employers may only have one request document on the system at any one time.

Also at the employer homepage will be a new search tool that allows an employer to list all applicant uploaded response documents within a chosen date range, status (new, pending, complete), and the two descriptive text fields. Employers will be able to sort and filter by status and/or date. The list will include basic information such as applicant's name, email, zipcode, and date of upload, and the descriptive text supplied by the applicant at upload. The system will also indicate if the applicant has a resume on line intended for the employer. The employer may then search for system Resumes using their own EmployerIdent and the Applicant's email address.

Industry Lookup: Applicants will have the ability to flag their accounts as belonging to one of several Industry types. These types will be those that are commonly known and used by job boards. They will exists within a standalone table so as to be easily updated. At the employer homepage, employers will have the option of adding industry types as a search filter.

Employment References Verification

Data Import/Export Integration: The Intranet component will need to talk to the employment references verification system. As applicants submit reference data to be checked, this data will be exported to the verification system. During the process of verification, status updates may be imported from the system. As verifications are completed, the system will import this completed data from the system. This task is for all code associated with this import/export integration. All data imported from the verification system will be stored in the local SQL7 database along with other intranet related data.

Manual Reference

Manual Reference Queue System: Before the verification system can be used, verifications will be done manually using another system in use now. This task is for the creation of a simple administrative tool that will allow users to transform data between this existing system and the database. Users will copy the relevant data from the system as entered by an applicant. They will then paste it into the screens where appropriate. As data is validated, the user will update the appropriate fields to indicate that the data point has been verified. Other fields, such as notes, will also be accessible using this manual system.

Integration Scheduling Service: There will need to be a mechanism whereby the data integration between the verification system and the Intranet database occurs on a regularly scheduled set of times. It is suggested that a scheduled service be written to handle this transaction. The service would run automatically and be configurable.

Licensing

School Data Management System: The licensing validation system will use a database of schools. This database is intended to give the licensing validation user the ability to quickly obtain information about specific schools such as contact numbers, dates of operation, etc. It is unknown whether or not this data will be capable of being imported into the local database of the system, and how easily such data could be kept up-to-date. At the least, there will be one or more support fields, such as “school notes”, which may act to augment an external reference datasource.

Work Queue System: This is the main tool for the user doing the work of licensing validation. As applicant data is submitted about degrees and licenses, it will go into a work queue. Users of the system will be assigned the job of checking this data based on the user's current queue load. This queue will include a status flag for the particular applicant that can be set to new, pending, or completed. The date of completion and a notes field will be included as well. This data will be available to the applicant via the Applicant's Verifications Review Screen.

At the queue screen worker will be able to auto-generate a fax form to be used in one of the following conditions: in those situations where a fax is needed (school only wants to confirm by fax); a consent is needed and we need a cover page; money is needed and we need a cover page when we send our check for $3 to $5. This fax form will contain core applicant data: Applicant name, Social security number, Name of school and reference info (sates, degree), Fax number to return the completed form, if they will complete by fax, a separate 800 number for use when a callback from school is expected. The worker will be able to set this fax form as being sent to a professional credential institution or an educational institution.

The invention provides a personal, web based, verified lifetime job history. The service will independently verify a personal entire job history, creating an indispensable tool for job applicants. When a person goes job hunting, they can provide their password to an employer or recruiter, who can instantly see a person's verified employment and educational history. Just like a person would not go apartment hunting without a credit report, or house hunting without a pre-approved mortgage, no one should go job hunting without an independent verification. Eventually, the web site becomes the largest database of verified job histories in America, which carries a number of other economic possibilities.

The inventive system will create the first human capital database—that is, a database of independently pre-verified and documented information about the work histories, educational histories and professional credentials and licenses of millions of Americans. Within a few years, employers and recruiters will be able to instantly obtain the verified credentials and work histories of applicants just as easily as firms can now obtain credit reports. The information that goes into database will have been independently verified through.

As a result, applicants can use these services to instantly validate who they are when they seek employment, and employers and recruiters can instantly verify who they are considering. We believe this could represent a fundamental shift from the current industry practices that essentially rely upon what an applicant says about themselves in resumes. The only way verification occurs currently is to wait until well into the selection process, and to hire an outside firm to conduct a pre-employment screening.

This invention will create a human capital market, so that human resources can move freely. The goal is to create a system where the right person is matched to the right job at just he right time, with a minimum of delays and transactions costs. This is done by creating a source of verified information about the work force that allows both employees and applicants to make instant decisions.

This process will be used to develop a large-scale database of the verified work histories of American workers. In a sense, this will become the fourth national credit bureau. However, instead of credit information and public records, the database will contain verified work histories.

By creating a permanent employment record to verify past employment as well as education and credentials, the inventive system helps both job applicants and employers in the employment process and by providing quick, efficient and cost-effective referencing services. In providing these services, the operator should be committed to maintaining the confidentiality and privacy of information obtained and in protecting the legal rights of all individuals in the database. All services and uses of the database should be done in strict compliance with all state and federal legal regulations, including the federal Fair Credit Reporting Act, the federal law regulating these services.

Based on government and institution information, it is estimated that currently 10,000,000 to 15,000,000 background checks are performed annually. This figure is expected to rise dramatically over the next five years. Every business day some 1,500 work related lawsuits are filed in this country. Due diligence in verifying all claims on an application is becoming a de facto standard.

According to the U.S. Department of Labor 1,000,000 jobs are filled annually. Americans will change jobs eleven times or once every 4 years over a 45-year working life. Some companies select up to five finalist candidates for each job and conduct a background check on each prior to the final selection. Even when these “best practices” are not followed, the average applicant will be a finalist for up to five positions, while searching for a new job.

These figures also do not include employment and staffing agencies that are likely to use employment checks if the pricing and turnaround time meet their needs. It also does not include a number of Internet sites that would likely offer employment verification through a service such as the inventive system.

Industries that could use the inventive system to obtain reference information include:

Background Screening Firms: There are some 3,000 employment screening firms in the US that provides a full array of background services to employers. Theses firms typically outsource as much as possible. There is currently no service in the US that provides wholesale reference checking to these firms (that do not also compete with them by providing other services).

Staffing Agencies: One of the largest types of employers in the United States is staffing companies. A major problem and cost for staffing firms is reference checking of past employment. Our goal is to create a third party outsourcing opportunity that can accomplish these checks faster and more cost efficiently then staffing firms do it themselves.

Employers: Large employers may also wish to contract directly with the service for reference checking. Employers of all sizes would benefit from the inventive system

Web sites aimed at staffing and independent contractors, or job boards: There are an increasing number of web sites that are aimed at matching employment opportunities with independent contractors. There are also a very large number of sites that offer placement or job listings. Eventually, these web sites will migrate to providing some level of verification of credentials and past employment. The inventive system is well placed to provide that service. Currently, on-line recruitment and job sites are essentially nothing more then resume search engines. Some limited efforts have been made to provide verification, such as on-line ratings, skills testing, or completion of on-line courses, but none of these approach the level of having pre-verified candidates.

Job Applicants: The inventive system can also offer a service that will allow job applicants to be “pre-qualified” through a separate service. Just as a renter would not go apartment hunting without a credit report, or a person house hunting without a pre-approved loan, a person should not go job hunting without a pre-approval.

Industry Groups and Associations and Industry Job-Pools: The inventive system can be utilized by industries or association that wish to create a database of pre-verified and qualified workers for that industry or to create pools of pre-qualified available human resources.

Risk management firms: Risk management and statistical analysis is a large industry in the United States. With a large database, the inventive system will be able provide valuable statistical data about the American workforce.

Financial management: The verified data can be used by financial organizations making credit or insurance decisions, including but not limited to loans of all types.

Statistical Analysis: This information will be invaluable to a detailed statistical analysis of the American workforce and working habits, providing a high degree of detail as to exactly what the of positions are filed, what type of experience workers have for certain jobs, average length of stay and numerous other possibilities.

The invention solves several problems in the United States, including but not limited to the following:

The first problem is that there is not a standardized system in the United States for employers or job applicants to verify credentials, including past employment, education or professional certifications or licenses. Employers have no database to go to ensure that a person has in fact worked where they have said. They need to call past employers themselves, or hire a service. Applicants can also have difficulty confirming past employment, if past employers have merged, moved, changed names or gone out of businesses. Once the inventive system reaches a sufficient size, it can even issue an access number that a job applicant can share with a prospective employer that allows an employer to come to the website to confirm past employment.

Secondly, there is no true human capital database in America. Various Internet job boards will have large numbers resumes, but none of it is verified or useable in a standardized format. The millions of resumes field with job boards consist solely of what applicants choose to say with no independent verification whatsoever. Employers, staffing firms and background firms all have massive amounts of data that they have gathered for their own use. However, no where in America is that information aggregated, combed or unified is some useable format. The data exits in literally millions of discrete locations, which absolutely no means, system or method of aggregation, analyst and retrieval. There is no standardization or aggregation of the data.

Underlying Technology: MyJobHistory has developed a proprietary database application that manages the reference checking process as described above. Although the methodology is proprietary, the underlying software language is generally accepted industry standard, including Sequel, Java, ASP and Microsoft and IBM products for the Business to Business (B2B) connections. The B2B also utilizes XML in order to be a universal interface.

This site is for both employers and job applicants. Job applicants will come to the site to obtain a personal lifetime verified job history that they can use for employment, financial applications, etc. Just as a person would not go apartment hunting without a credit report, or house hunting without a mortgage, no one should go job hunting without having his or her job history verified by the inventive system

In addition, it serves as a place where an employee can go confirm and record all jobs. After each job, they could go back to the site and verify the job they just left. It will also verify education and professional licenses and credentials.

For employers, it is a place to come to verify a job history for an applicant who gives the employer their mailbox and password. There is no charge for employers. A companion site called would make the same information available to financial institutions for a fee.

Operations:

Summary: Applicants come to the site. They first get a password and ID. They can then record their job history, and for a fee the system operator will call and verify past jobs. This means that each applicant has a site or personal page where they see the report about their job history, as it is put it together. The operator would contract with a third party Credentials Verification Organization (CVO) agency that certifies that an independent verification has occurred. A user needs a credit card to put the order through. If an applicant disagrees, they need to e-mail us with all detail that we would pass on to the past employer. The reference is posted only after an applicant approves it.

The employment references verification system offers different levels of service. The first is a verification of job history—start date, end date, job title, salary (if they will confirm it). The second is references from an individual. There is also a procedure for individual references. The cost of a reference is higher, because we need to find the person, and we may still need to call Human Resources, Staffing or Payroll. In addition, we need to be able to independently confirm that the person was a co-worker or supervisor. That will be done in two ways-first, by the applicant providing the firm's name, and the operator independently obtains the phone number through public sources. Or, if the person is no longer at the firm or employed, we need to verify that the person was at the firm. So, we need to do a verification of the verifier.

When an applicant applies for job, they give their password and mailbox to the employer. An applicant always has the right to change the password. So, when an employer logs on, they put in the password and mailbox, they then have to say who they are. The applicant then gets an auto e-mail that a certain employer was looking at their site. We also capture employer info. If the applicant has obtained a new job, they can come back to the site and change their password. A message then comes up saying, e.g., “Thank you for our inquiry. This applicant has changed the password on this verified job history. For further information about the service, please click here.”

At this point, the employer agree to certain use limitations, such as the following:

The employer verifies that they have in fact received the password and mailbox from the applicant, and therefor the use is permissive;

The data will only be used for the purpose of employment decisions, and will only be seen by those involved in employment decisions and will otherwise be kept private and confidential;

That information will not be used to discriminate in violation of any state or federal law;

That this is a one time use only, and that information may not be stored, or used, sold, given away, etc.;

That by using this site, employer understands that every effort as been made to verify the info, etc, but we accept no liability for any hiring decisions, etc.

E-commerce aspect: The e-commerce is tied into the inventive site. The e-commerce package is very straightforward—the service bills a consumer when a request is made-however, the service does not access the credit card until verification or reference is returned.

The service may have two pricing structures. One is for verifications. The other is for a reference. However, the applicant needs to give us a current location for the reference, at a number that the service can verify through an outside source, such as information.

Reference procedure: It is very important to clearly understand the difference between a verification and reference. A verification is start date/stop date/job title/salary only. A reference would be a number of questions such as eligible for rehire, good points, weak points, etc.

The service makes it very clear to employers and applicants that:

We do not get in the middle of a reference dispute. If an applicant does not like the reference that has been given, they can delete it

That we are not being used for the purpose of checking references by applicants who want to see what a past employer will say. We will make it very clear on our site that when we ask for references, we are an Internet site, and that the reference will be opted so that an applicant can allow future employers to see them. We would identity ourselves as doing employment references to verify the applicant's job history, and explain what it is used for.

Strict privacy policy as follows:

We only obtain past job histories pursuant to a written consent

We only give the information out if the applicant gives a consent (and we assume that an employer has a password that the applicant gave it to them). The information is never given to a third party, or used for marketing.

In the meantime, we utilize due diligence in the manner in which we securely store and protect the information.

Personal Client Page: Each applicant would need to have their personal page. It would actually be multiple pages that allows the applicant to control their interactions with the service, and a page that employers would see containing the actual verified job history. On the personal client pages, clients can do the following:

Place an order for a verification and/or reference, including all details needed;

Pay for it by credit card;

View their history to date (i.e. everyone who has registered to see their verification, and if it was successful. If the applicant has changed passwords, then they would also know who looked at them and was unsuccessful.

View the results of a verification or reference.

Decide whether to post it, or to ask that it be re-investigated.

Decide if they don't like the reference to just post the verification

If they want it re-investigated because of an error, we will make one additional inquiry for free-However, the applicant must understand that: If they want us to recheck, they must first talk to the employer. They then tell us when it is time to recheck. After they contact the employer themselves to resolve a dispute, and then tells us it has been resolved and we will send a new request. Not post something that we did if they don't like it. In other words, an applicant can either accept our posting, not accept, or contact the employers to get things clarified and have us re-contact.

Password changing—an applicant can change the password to deny entry by employers if they have found a job they want, and do not want to have anyone see their personal verified site.

Send e-mail to customer service about references, in order to ask for a change, dispute a reference, etc.

A place where the applicant can indicate if they want to be made aware of opportunities that match their skills. In other words, the service cannot be used by recruiters to find applicants. But, if an applicant agrees to be the subject of permissive marketing, then we can work with recruiters.

If an applicant gives permission, we can use our site to send e-mails to prospective candidates that match certain jobs. In other words, we don't want to compete with job sits or recruiters. But, if a candidate wants to know about job opportunities, then we can send the candidate an e-mail about certain jobs that are available and provide an opportunity to respond if they are interested. It would e a “permissive marketing” situation. That gives us some job hunting as a secondary pay-off. We can partner with a job site that has employers seeking qualified candidates.

Employer Site

An employer can come into the system and put in a password to get to a particular applicant site.

Before entering, they need to identify themselves, as an e-mail can be sent

They then go to a terms and conditions page

They then go to a page about the service.

They then get to the applicant's verified resume.

Also, the site has the following additional functionality:

Applicants can use the site to download letters of recommendations. Those then stay with them forever.

Each letter becomes a request for a personal reference, where we contact the letter writer and confirm they wrote it, and then confirm the letter writer actually worked for the company—back to the dual verification of verifying the reference. Also, it is critical to check the job title of a verifier to prevent collusion—two employees promoting themselves by claiming to be the other's supervisor—if we check job title, that would help prevent that.

Pre-verification of criminal records—the service may be used by an applicant to self-check their own criminal record, for the purpose of providing an employer with a criminal check. The service can also be used for other services, such as civil suits and driving records.

Industry pools—An industry or association can use the service to create pools of pre-qualified individuals.

Use by firms to use the service as a hiring site.

Technology: On the pages where applicants place orders, or employers put in passwords, the technology would be very straight forward programming, such as an Active Server page, Java, or standard database and B2B tools.

Safe Hiring Score—the service has the ability to add a safe hiring score, similar to a credit score. In verifying credit, certain information such as education and previous jobs remain static—that history does not change. Other information, such as a criminal record check, becomes stale the day after it is run. However, based upon the totality of what is known about a person's verified job history, even an older criminal search will have some value. For example, if the service provided a criminal search for a county in Nebraska two years ago, and has since determined that the individual has an uninterrupted job history in Los Angeles, then it is unlikely the person went back to Nebraska to commit a crime. The service will score the person based upon what is known and verified about the person. If the person has an updated criminal record, the score would become higher. By using this methodology, an employer can immediately ascertain a person's safe hiring score based upon known information.

Factors include:

Factual verification of past whereabouts based upon verified employment and education;

Past criminal record checks and dates

Information obtained form social security trace report.

Geographical area covered in past checks

Statewide database information as available.

Additional uses: The inventive system can also be used in the following ways:

Used to assist recruitment efforts: Employers benefit from the service in several ways.

First, knowing that a candidate went to the service for verification shows she is willing to have her resume subjected to independent verification.

Second, it speeds up the hiring process—you can see whom you are getting, without having to undertake your own verification process.

Third, you can use the service to search a unique database of resumes for pre-verified applicants.

Fourth, you can use the invention's site as your own resume-collection center. Designate MJH as your official resume-collection site. Provide applicants with a special employer code (in your announcements or help-wanted ads.) Applicants are directed to a special page. There they can register their resumes for free (although they are given an opportunity to utilize the services if they choose). However, it is absolutely free to the applicant to register for the job). On the page, the applicant fills out a short cover sheet, providing contact information, the job he is applying for (either the title given by the employer or a generic description), and a short, 50 word description of his knowledge, skills and experience.

You also have two options. You can download your own applicant form onto the site for the applicant to upload. Or, you can ask an applicant simply to upload her own resume. You then can access applicant information on a private employer page. The listing is broken down in an easy-to-use fashion with several search tools. You get a listing by name, date posted, job title or area of interest, whether the applicant has a verified resume, the 50 word summary of knowledge, skills and experience and a link to the application or resume. You also are provided with search tools, to help utilize the data. The resumes are stored on the servers for two years. In addition, the service provides the applicant with a page that automatically affirms that the information has been received. The last two features help employers comply with legal requirements in many states.

The system takes the guesswork out of hiring by providing the employer with independently pre-verified facts about your candidates. No longer are you forced to accept applicants' statements about whom they are or what they did, only to find out later that this information is not true. No longer do firms need to delay hiring decisions to conduct costly and time-consuming reference checks. When you read Reports from applicants who have used the service, you know you are dealing with bona fide candidates who are ready, willing and able to have their information verified independently. That saves you time and money in the recruiting process.

A Seal of Verification on a Report or a Certificate of Verification shows that you are looking at a pre-verified candidate. The Seal or Certificate of Verification will contain an Access Code and the JobSeeker' ID (their e-mail address). Simply enter the information from hardcopy into the system, and you can instantly see an applicant's Verification Report.

The service independently verifies past employment education and credentials. This information, which is independently pre-verified through the system, belongs exclusively to the system. A JobSeeker has no access to the operator's portion of the report. A job applicant can also use the report as an online resume. The JobSeeker has a text box before and after the verification where they can add a cover letter, resume, skills summary, etc.

By using the service, an employer can review a candidate who was pre-screened by an independent, outside professional Credentials Verification Organization (CVO). Many job sites use the word “screened” simply to mean that the candidate's non-verified resume is submitted to some sort of matching software. When the inventive system says a candidate is screened we mean that we have conducted independent professional checks to verify the facts, including past jobs, schools, professional certificates and credentials. In addition, the service is ongoing, and not a one-time static background check.

If an applicant has designated their Verification Report as non-restricted, then you do not need to register. You are then taken directly to the Verification Report (after consenting to conditions of use.) If the applicant has requested that s/he be told who is looking at her/his Report, then you are directed to a “Quick Registration” page that takes about 10 seconds to complete. When you register, your privacy is protected 100%. There is no unsolicited marketing, and employer information is never sold or shared in any way without your permission.

The JobSeeker ID is an applicant's e-mail address. Each applicant using the service will supply their JobSeeker ID on their Seal or Certificate of Verification.

An Access Code is a code word or set of numbers that a JobSeeker may give to a prospective employer to allow that employer to access his or her online Verification Report with the service. Use of Access Codes allows JobSeekers to protect their information from unwarranted access.

An applicant is automatically e-mailed anytime anyone looks at his/her Report. If an applicant has registered an “unrestricted Report,” then s/he is informed only that it was looked at, and no other details are available.

If the applicant has ordered a “registered” Report, then the information obtained in the registration process is forwarded to the applicant.

The service verifies employment, education, professional credentials and licenses. For employment, the service will attempt to verify start date, end date, job title, and salary. For education, the service will attempt to verify dates of attendance and degrees granted. For professional credentials and licenses, the service will attempt to obtain the name of the credential or license, any identifying number, the name of the issuing agency, when obtained and periods of validity. The service preferably does not obtain subjective or reference information from past employers, such as “Please describe the quality of the applicant's work,” or “Did the applicant show leadership skills”. The reason is that there are too many variables. The service will obtain and report only factual matters.

The service utilizes the services of a nationally recognized independent Credentials Verification Organization. This is an independent, third party that specializes in contacting past employers and schools to verify information on behalf of employers. The CVO uses accepted industry practices and techniques to obtain information on behalf of job applicants. The primary method is to make telephone contact with the appropriate party. On some occasions, fax and mail are used to obtain the information. The CVO also has access to various national and regional databases.

The service may optionally offer a premium service where we acquire actual reference information about an applicant in addition to dates of employment, job title, and salary. However, qualitative reference questions (such as “Describe the applicant's strengths”) can be very sensitive matters to past employers and applicants alike. Many employers will provide only factual information and have a policy against reference information. In addition, most prospective employers have their own specific questions when doing reference interviews. In addition, it is difficult to judge the usefulness of third party reference checks. However, just having the verified facts is extremely valuable in a job search. It allows an employer to focus on just the top candidates.

Although the service provides Reports that have been pre-verified by a professional Credentials Verification Organization (CVO), the services are governed by our Terms of Use for the site, as well as applicable state and federal laws and regulations that are applicable to all employment decisions.

The service does not act as a guarantor or insurer that you are hiring the correct candidate. The hiring decision is completely up to you. The service verifies that a candidate has the job history, and educational and credentials that they claim.

If a JobSeeker provides a staffing agency or recruiter with a service Access Code and JobSeeker ID, then that candidate can be instantly verified. For a staffing firm, a verified applicant could be sent out to work that day. For recruiters, the service saves valuable time and energy by giving instant verification. Staffing firms and recruiters can cut the placement time dramatically by suggesting to JobSeekers that they come pre-verified.

An employer should still conduct whatever due diligence they normally perform. The value of the service is to help employers sort through a sea of resumes and focus on those candidates who were willing to have their qualifications scrutinized. An employer is still well advised to take their normal steps to make sure a person is a good fit for the job and organization. In addition, a firm may still wish to conduct a criminal record check.

The inventive service can help job applicants in the following ways:

Use the service as your permanent lifetime job history site. In today's economy, as firms move, merge, go bankrupt or re-organize, it can be hard to get documented verification when you need it that you actually worked for a company.

Use the service in your job search to confirm yourself as a verified and bona fide candidate. No longer do employers have to wonder whether your resume is among the 30% of all resumes that contain falsifications or omissions. If your Verification is from the inventive service, the employer knows you are for real.

Distinguish yourself from the crowd with a Verification Report showing your independently verified job history, education and certifications.

Customize your Verification Report for a specific employer—when you give that employer your Access Code that employer can see the report created exclusively for them.

Put your uniquely generated Seal of Verification on your resume or cover letter, and a potential employer can use the JobSeekers ID and Access Code to instantly look you up on line.

Utilize the Certificate of Verification that is uniquely generated for each user. A Certificate, which contains your JobSeeker ID and Access Code, can be given to an employer along with your resume.

There are millions of resumes on the Internet, and they all have one thing in common—they all depend upon what people choose to say about themselves. Yet employers know that up to 30% of resumes contain serious misrepresentations or omissions.

The service verifies employment, education, training and professional credentials and licenses.

For employment, the service will verify start dates, end dates, job titles, and salary data (if past employers will provide this information). The service does not obtain reference information from past employers, including such qualitative questions as “Please describe the quality of the applicant's work” or “Did the applicant show leadership skills. The reason is that there are too many variables.

For education, the service will verify dates of attendance and degrees or certificates granted. This service may be limited to the US, New Zealand, the United Kingdom, Australia and, English-speaking areas of Canada.

For professional credentials and licenses, the service will obtain the names of the credentials and licenses, identifying numbers, names of the issuing agencies, when obtained, and periods of validity. The service can also obtain verifications of Certifications from courses completed or exams taken in the United States only.

Advanced Tools allow you to create and manage multiple custom reports with specific employer greetings, and your resume and/or cover letter. Select to receive an e-mail when an employer views your verifications

The service normally requires seven working days to obtain the information. This excludes weekends and holidays. However, some delays may be beyond our control. Such delays can include:

Insufficient information from you, the customer, to locate a past employer. In that case, the you will be contacted and asked for additional information;

Delays by a past employer, school or organization in responding;

Schools that are closed for the summer, or that require advance payment of a fee to provide the information.

An Access Code is a code word or number combination that a JobSeeker may give to a prospective employer to allow that employer to access his or her on-line Verification Report. Use of an Access Code allows JobSeekers to protect their information from unwarranted access.

A JobSeeker ID is the e-mail address you use to sign up for the service. Your e-mail is critical. You need to a potential employer along with your Access Code so they can look up your verification online. It is also used for all communication between you and the service.

The information stays in the database for your future use. Since the service is a lifetime verified job history site, it can assist you throughout your entire working career. After you find your job, you can simply de-activate any Access Code and no one-can look-up your Verification Reports. If you are in the job market again, you simply go online and reactivate the service. Of course, you may wish to add another verification, such as your last employment.

The FCRA is the federal law that governs the use and collection of information for employment purposes. For an applicant, the most important point is that a consumer reporting agency may not collect or utilize the information without your specific approval. In the event you apply for job, and you signed a FCRA release, then the information is made available to a consumer reporting agency help you get that job.

The service preferably uses a fully protected SSL secured server. It is the same technology used by other sites that contain sensitive and confidential information. Of course, that does not mean that no one could ever break into a secured web site. After all, no web site in 100% guaranteed. However, we use state of the art procedures to provide maximum protection.

The information is made available to employers in one of several ways.

You can prepare a Verification Report targeted for a specific employer and preface that report with a special greeting. When that employer uses the Access Code, the employer receives your personalized greeting. When that Verification Report is viewed online, you also will get an e-mail automatically. That way, you know when an employer is viewing your Report.

After you have ordered a verification and it has been completed, you will be able to create a Seal and/or Certificate of Verification to include with your Report. It will contain your JobSeeker ID and Access Code, giving employers a direct link with your online Verification Report.

You can require that any employer who wants to view your Verification Report register at the service. That way, when an employer views a Report, an e-mail is automatically sent to you with the identity of that employer.

The service may provide up to six different Verification Reports with four (4) Access Codes for each. That gives you the option to have Reports targeted at a whole market, and still have the flexibility to target a particular employer.

You can have up to four (4) different Access Codes to give out.

The inventive service is also ideal for independent contractors (IC) and free agents. One of the challenges facing an IC is validating past work. Now, by using the service, an IC can maintain an ongoing list of verified projects. At the end of a significant assignment, an IC simply goes to the service, and requests a verification of the assignment just completed. In the future, prospective employers can view an IC's verified Report on the service web site and see a whole list of satisfied past clients. If an IC is using a Free Agent job site, be sure to include your Access Code number on your listing, so potential clients can immediately see who you are and what you have done.

Another aspect for the inventive system is to use the database and procedures to create a universal record that can be utilized in the human capital marketplace as part of a national credentials database. With such a tool, employers would be able to instantly match the right person to the right job without undue delay and transition costs by using the UACR to instantly match jobs to applicants.

Another aspect of the inventive system is to allow vertical databases by industries or profession. For example, the inventive system can be used to created databases of truck drivers, architects, respiratory therapists and so forth. This can be done in conjunction with industry associations or job boards that specialize in a particular industry. It can also be done in a partnership mode, whereby an industry trade group or professional association can offer the inventive service as a benefit of membership (perhaps offering a discount), and the sponsoring group would also get a percentage of all business generated.

Another aspect of the inventive system is the ability to create a “security score” or “safety index” similar to a credit score. It would also be utilized to verify an identity database. A “security score” is a numerical valuation based upon combining information as to where a person has been physically located as verified by the service, along with other pubic records, such as criminal check, information maintained by credit bureaus known as a social security trace and other data maintained in public and private databases.

A criminal record search or database search alone is of limited value unless it is tied to a database that confirms where a person has been. The inventive system can provide the essential data about past whereabouts by confirmation of a person's credentials (employment and education) that can be combined with other data to create the first model whereby a person can receive a security rating. This can be used not only for employment, but also by any private or public entity that needs to do mass screening for safety or security purposes, such as airlines and airports.

Contrary to popular belief, there is no government background-checking computer where employers can submit a name and instantly get a thumbs-up or a thumbs-down. There is no national computerized listing available to private employers with a person's criminal record or past employment history instantly available. Although the Social Security Administration maintains records based upon employment, that is not available to private employers. In addition the government and the states maintain criminal databases. However, most private employers have no access to those unless access is specifically mandated by law. In addition, the official government rap sheets often have statistically significant miss rates. That is due to the inherent problem is a large massive database, that needs to record criminal cases in the federal at the federal level and 50 state courts, and the problems associated with various names clerical errors, and updating case status.

For private employers or entities concerned about pubic safety (such as airports and airlines), obtaining information on a person's background including criminal information is very difficult. A private company must obtain criminal records the old fashion way—sending human researchers to each relevant courthouse to check records. The difficulty is that there are some 10,000 courthouses in the US spread out over approximately 3200 state and federal jurisdictions, making finding a needle in a haystack easy by comparison. If the right counties are not searched, the information will not come up. It gets even more complicated because human beings conduct the search typically by performing some sort of clerical function. As with all endeavors relying upon human intervention, errors are not only possible, but also highly likely. The same issues also exist with official government criminal record databases.

The bottom line is that criminal record checks, although extremely valuable, are never a standalone tool. They must be combined with other tools, such as a past employment checks to pin down where a person has been and to eliminate any unexplained gaps in employment. The critical issue is that if an employer or firm does not know where a person has been, there is no way of know which of the 10,000 courts to search.

In addition, in order to verify identity, credential checks are also critical, in that it verifies a person's statements about their histories and can be used in connection with numerous private and pubic databases.

The key is that a background check and identity verification quires various overlapping tools—no one tool does the job. Any type of background check or security/safety rating must incorporate information as to where a person has been. The most effective way of dong that is to know where a person has gone to school or where they have been employed. Confirming dates of employment and job title is of the utmost importance. It confirms the applicants qualifications, demonstrates due diligence and most critically, lets an employer know where a person has been, so the employer knows where to search for criminal records. Otherwise, the employer is hiring a stranger with no verifiable past.

For example, if the 9/11 hijackers had faked resumes in order to apply for a job at a sensitive industry, a criminal record checks may well have cleared them if they had not committed a crime in this country. However, by verifying “past employers,” it could have been revealed that their past employment was fake. Not only would their veracity have been questioned, but it would have been revealed that the “applicant” was a stranger without a verifiable past—that would have been the tip-off.

By knowing where a person has been, an employer or entity is not only to determine where to search, but can also lessen the possibility that the person has committed a serious offense and spent substantial item in custody.

In addition, criminal record checks are outdated the very day they are performed, since a person could have committed an offense the day the check. However, if a criminal check is combined with verified credentials, then a value can be calculated mathematically as to the value of the criminal record currently, given what is known abut what a person has done since the last criminal record check and where they have been. For example, assume a person had their last criminal record check in 2001, but the inventive service has verified continuous employment since then. If a person has verified continuous employment, it lessens the possibility that the person spent time in jail or prison for a serious offense. As a result, the information can be molded into a safety or security score.

As a result, a critical portion of the inventive service is to utilize the credential data, in conjunction with criminal records and other public record data such as a social security trace database and other location databases, to allow an employer to access the security/safety score for a consumer.

The inventive system also has the capacity to perform criminal record searches for appellants as well as reference checks (which is a qualitative list of questions that go beyond factual matters such as start date, end date and job title. A Reference questions involved questions concerning ability, knowledge, skills and performance, such as strong points, week points, areas where improvement needed, example of successes, eligibility for re-hire, etc.

Another aspect of the inventive system is the fact that the system provides a lifetime repository of information, and not merely a one point in time screening repot. The service does not simply sell a static screening report that is valid up to the point at which the report is provided. Instead, job applicants for the first time have the ability to maintain a report for their entire working life, and to add to the report any new credentials.

In addition, job seekers can deactivate the report so an employer cannot see it if they find a job. If they again need the service, an applicant can re-activate the service. In addition, an applicant can have up to six different online verifications and also chose to require employers to register so that an applicant knows exactly who is looking at them. If no registration is required, the applicant will merely get an e-mail that someone has looked at his or her resume.

As a result, the inventive system does not merely provide a one-point in time summary, but provides the tools for a job seeker or independent contractor to verify themselves over their entire working life with a tool that is utilized by job seekers to employers to find employment.

In addition, an employer can be linked to a background screening firm or strategic partner in order facilitate the employer in ordering additional background screening tools. Although the current model allows employers to review resumes at no cost to the employer, the service can also be used for industries where employers are mandated to undergo certain credential verification procedures, or where a job seeker is mandated by law to have certain credentials. In those industries or occupations, the system also includes the ability to charge the employer for the ability to review credentials. In addition, the system can be utilized as an applicant database, whereby employers are charged to locate candidates with certain credentials, as well as other screening criteria including but not limited to geography consideration, years of experience, a particular license, etc,.

Another use of the system is to provide independent contractors the ability to track jobs and assignments, in order to provide a portfolio that can be sued for future jobs.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Therefore, the above description and illustrations should not be construed as limiting the scope of the invention, which is defined by the appended claims.

What is claimed as invention is:

1. A method for creating, editing and updating, verifying, and referencing a database of work, educational, and licensing histories of workers, said method comprising the steps of:
providing an internet service with secure means for prospective employees to enter and record on a database a personal educational and job history covering any time period;
providing semi-automated means for verifying the history provided by the job applicant and for building a verified database of workers.

2. The method of claim 1 further including the step of:
providing a secure, confidential and private means for a prospective employer to review the verified educational, employment, criminal, and licensing history of the worker.
